(19) United States
(12) Patent Application Publication
(10) Pub. No.: US 2008/0046230 A1
(43) Pub. Date: Feb. 21, 2008

(54) RECEPTION SUPPORT SYSTEM AND PROGRAM THEREFOR

(75) Inventors: Kenzo HIRAIWA, Kawasaki (JP); Kazuhiko Nakatsu, Kawasaki (JP); Azusa Matsumoto, Kawasaki (JP); Tomohisa Misawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/617,125

(22) Filed: Dec. 28, 2006

(30) Foreign Application Priority Data
Jul. 14, 2006 (JP) 2006-194793

(51) Int. Cl. G06F 17/28

(52) U.S. Cl. 704/3

(57) ABSTRACT

The system carries out a voice recognition process for generating a log file by converting a voice signal uttered from the client terminal and operator terminal into a text, and storing the log file in a log database by being correlated with the client terminal for detecting a presence of a point of the operator asking again in a text of the log file which is used for setting a level of each client as attribute information, followed by selecting a level based on the number of times of the operator asking again by referring to an attribute information content update database including a condition for changing the attribute information based on the detection result and updating a database recording the attribute information for each client.

### BACKGROUND OF THE INVENTION

1. Field of the Invention

The present invention relates to a technique for updating attribute information of a client for use in a reception support system oriented to a foreign language.

2. Description of the Related Art

In recent years, an operator sometimes handles many products or services in a reception service, such as a system support service operation. Consequently, knowledge is required on the product and/or service. Also a capability of an accurate response is required when receiving an inquiry and a consultation from clients related to a product and a service provided by a foreign business enterprise. It is, however, sometimes not possible to respond quickly to a client by sorting out information or hand the information in Japanese when receiving a consultation or problem from the client in a foreign language (which means any other language other than Japanese in this specification), et cetera. For example, some foreign-affiliated enterprises mainly using foreign languages use a support desk specialized for foreign languages and provide a reception service somewhat short of a sufficient service.

Accordingly in recent years systems are proposed for carrying out an information display and voice processing for providing in operator terminals so as to support in problems stemming from differences in manners of speech, knowledge levels, et cetera, specific to each of the clients.

A patent document 1 has proposed a call reception system including a server comprising a database for registering information related to a specific person and an operator terminal comprising a display apparatus, in which the server identifies a call from a specific person and displays the identification result in the display apparatus, thereby enabling an identification of the specific person and an appropriate response to the identified specific person.

A patent document 2 has proposed an information processing apparatus capable of performing a process in response to a dialect without setting an attribute of a client in advance, comprising: a dialect dictionary storage unit for storing a plurality of dialect dictionaries for showing a relationship of a dialect which is different from region to region with the standard language; a communication unit for carrying out a communication with a telephone of a customer as a correspondent party; a positional information obtainment process unit for obtaining positional information of a telephone of a customer; and a conversion process unit for reading, from the dialect dictionary storage unit, a dialect dictionary corresponding to a region including the positional information obtained by the positional information obtainment process unit and converting an expression mode of a content of a communication with the customer terminal between the standard language and dialect of the customer telephone side by using the readout dialect dictionary.

A patent document 3 has proposed an information provision system setting an information disclosure level proportional to a knowledge level value for each piece of electronic information used for a response in an information provision server, identifying a client level and a knowledge level value of an operator at receptions of information requests from a plurality of operator terminals as a trigger for example, editing the applicable electronic information according to an information provision rule set up for the identified knowledge level value, and outputting the edited electronic information to the operator terminal, thereby changing a method of an information provision according to a level of knowledge of the client or operator on an applicable product.

In order to carry out an appropriate support, however, attribute information of a client (i.e., product knowledge, language skills, et cetera) needs to be always adequate. That is, the information needs to be quickly sort out and handed to the client or support technician. There are problems associated with the need as shown in the following items (1) through (6): (1) a rapid talk of a client makes it difficult to hear, (2) a bad pronunciation of a client makes it difficult to hear, (3) a client does not have knowledge on the product, (4) a client provides no information that is inconvenient thereto, (5) a client has a unique manner of speech, and (6) if a client uses a local English if he is not a native English speaker, the operator cannot understand.

If there is a problem such as the above noted, the operator if faced with problems such as a repeated question to the client and an inability to put a problem of client's questions in order. Especially, in the case of a difficulty of hearing, such as (1) and (2) above, and of product knowledge not existing in the client, the operator is faced with the problem of not being able to send information back to the client or dispatch the information to a support technician smoothly by sorting out information.

[Patent document 1] Laid-Open Japanese Patent Application Publication No. 2004-040520

[Patent document 2] Laid-Open Japanese Patent Application Publication No. 2005-331608

[Patent document 3] Laid-Open Japanese Patent Application Publication No. 2003-224661

### SUMMARY OF THE INVENTION

In consideration of the above described situation, the purpose of the present invention is to provide a reception support system updating attribute information of a client, for a database related to a product knowledge level of each client and a good or bad pronunciation thereof, according to a judgment result extracted from uttered words included in a response log and response data (i.e., voice) between the client and operator.

According to one aspect of the present invention, a reception support system supporting an operator by equipping computer telephony integration (CTI) for connecting an operator terminal with a client terminal by way of a telecommunication line comprises: a voice recognition process unit for generating a log file by converting a voice signal uttered from the client terminal and operator terminal into a text, and storing the log file in a log database by being correlated with the client terminal; a search process unit for recording a product knowledge level of each client as attribute information, detecting a presence of a point of the operator asking again in a text of the database by comparing with a character string, which is stored in an ask-again key word database, used when the operator asks again, and storing the number of times of being identical with the character string; and a judgment process unit for selecting a level based on the aforementioned number of times by referring to an attribute information content update database including a condition of the number of times of asking again for changing the attribute information, and updating the product knowledge level in a database recording the attribute information for each client.

According to another aspect of the present invention, a reception support system supporting an operator by equipping computer telephony integration (CTI) for connecting an operator terminal with a client terminal by way of a telecommunication line comprises: a voice recognition process unit for generating a log file by converting a voice signal uttered from the client terminal and operator terminal into a text, and storing the log file in a log database by being correlated with the client terminal; a search process unit for recording a pronunciation level of each client as attribute information, detecting a presence of a point of the operator asking again in a text of the database by comparing with a character string, which is stored in an ask-again key word-2 database, used when the operator asks again if a pronunciation is incomprehensible, and storing the number of times of being identical with the character string; and a judgment process unit for selecting a level based on the aforementioned number of times by referring to an attribute information content update database including a condition of the number of times of asking again for changing the attribute information, and updating the pronunciation level in a database recording the attribute information for each client.

By means of the above described comprisal, the reception support system extracts the number of times of the operator asking again from response data (i.e., voice) of a database related to a product knowledge level of each client and a good or bad pronunciation thereof and, if the number of times is equal to or more than a predetermined value, judges that a product knowledge level of a specific client is low.

It also extracts a point of the voice recognition system being unable to recognize from an utterance of a client of a response log and, if the number of points equal to or more than a predetermined value is extracted, judges, and update, that the pronunciation of the client is bad.

This comprisal enables the operator to respond back to the client with information and dispatch the information to a support technician, both smoothly.

According to the present invention, a computer readable recording medium recording a program for making a computer execute a reception support system supporting an operator by equipping a computer telephony integration (CTI) for connecting an operator terminal with a client terminal by way of a telecommunication line, wherein the program makes the aforementioned computer execute: a voice recognition process for generating a log file by converting a voice signal uttered from the client terminal and operator terminal into a text, and storing the log file in a log database by being correlated with the client terminal in order to update a database including a product knowledge level as attribute information of each client; a search process for detecting a presence of a point of the operator asking again in a text of the database by comparing with a character string, which is stored in an ask-again key word database, used when the operator asks again, and storing the number of times of being identical with the character string; and a judgment process for selecting a level based on the aforementioned number of times by referring to an attribute information content update database including a condition of the number of times of asking again for changing the attribute information, and updating the pronunciation level in a database recording the attribute information for each client.

Also, a computer readable recording medium recording a program for making a computer execute a reception support system supporting an operator by equipping a computer telephony integration (CTI) for connecting an operator terminal with a client terminal by way of a telecommunication line, wherein the program makes the aforementioned computer execute: a voice recognition process for generating a log file by converting a voice signal uttered from the client terminal and operator terminal into a text, and storing the log file in a log database by being correlated with the client terminal in order to update a database including a product knowledge level as attribute information of each client; a search process for detecting a presence of a point of the operator asking again in a text of the database by comparing with a character string, which is stored in an ask-again key word-2 database, used when the operator asks again if a pronunciation is incomprehensible, and storing the number of times of being identical with the character string; and a judgment process for selecting a level based on the aforementioned number of times by referring to an attribute information content update database including a condition of the number of times of asking again for changing the attribute information, and updating the pronunciation level in a database recording the attribute information for each client.

Such a comprisal enables the operator to respond back to the client with information and dispatch it to a support technician, both smoothly.

The present invention is contrived to make it possible to receive a call and information from a client appropriately and quickly, transfer information to a support technician and respond back to the client with it.

### BRIEF DESCRIPTION OF THE DRAWINGS

FIG. 1 is a diagram showing an outline of a reception support system;

FIG. 2 is a diagram showing a comprisal of the present invention;

FIG. 3 is a diagram showing a structure of data stored in a database;

FIG. 4 is a diagram showing a text content of a log file;

FIG. 5 is a diagram showing a flow chart of judging a presence or absence of a product knowledge;

FIG. 6 is a diagram showing a judgment flow chart in the case of a bad pronunciation; and

FIG. 7 is a diagram showing a configuration example of a recording medium allowing a computer to read a recorded control program.

### DESCRIPTION OF THE PREFERRED EMBODIMENTS

The following is a detailed description of the preferred embodiment of the present invention by referring to the accompanying drawings.

### Embodiment 1

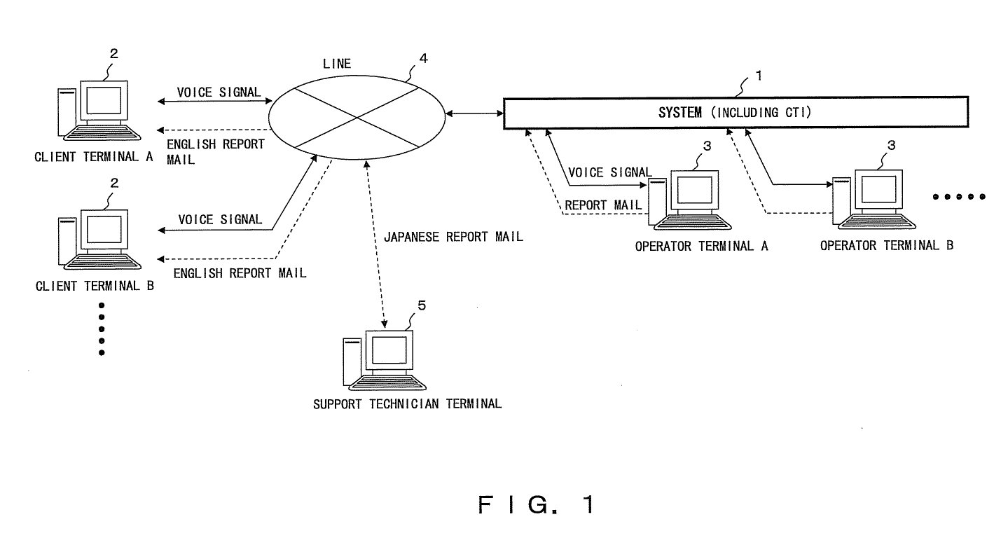

FIG. 1 is a diagram showing an outline of a reception support system according to the present invention. The reception support system has a system 1 comprising the present invention connect a client terminal 2 to an operator terminal 3 enabling a telecommunication by way of a line 4, et cetera. And it makes a report from an exchange with a client and transfers it to a terminal 5 of a support technician in order to respond to an inquiry of the client transmitted from the client terminal 2.

The system 1 has the computer telephony integration (CTI), et cetera, integrating a telephone and a facsimile into a computer system and is installed in a support center, et cetera, where an operator terminal 3 is installed. It also comprises a system collaborating with a client database so as to be capable of providing an accurate support by referring to a profile of a client and a history of responding therewith (i.e., an integrated client response system such as a customer relations management (CRM)).

In the case that a client needs to inquire on a product sold by a manufacturer for instance, the client terminal 2 is disposed for the client to exchange a voice signal with an operator on the side of the operator terminal 3 on the telephone by way of the line 4 (i.e., the private line, public line, Internet, et cetera).

The operator terminal 3 communicates with a support technician based on information obtained by the exchange. If the client is a foreigner using English for conversation, the operator sends a report in Japanese to the support technician who later sends a report to the client by way of the operator or directly. A telephone call may utilize a computer terminal as shown in FIG. 1, in lieu of being limited to a telephone.

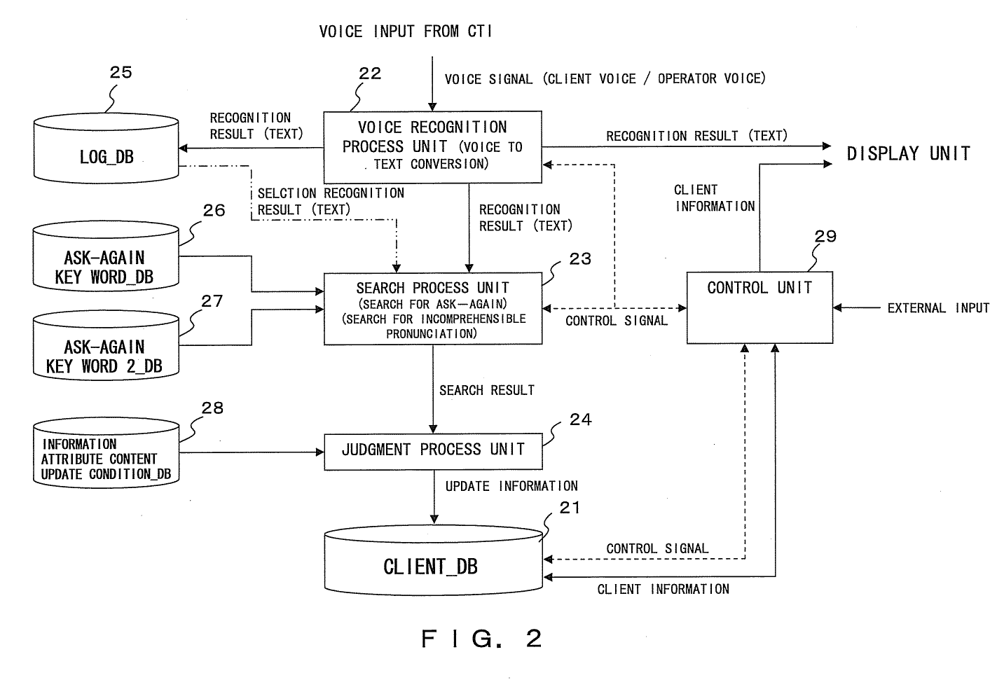

FIG. 2 is a block diagram showing a comprisal for updating attribute information of a client database 21 of an integrated client response system included in the system 1.

The client database 21 is updated by processes of: a voice recognition process unit (for conversion from voice to text) 22, a search process unit (searching for an ask-again, and searching for an incomprehensible pronunciation) 23, a judgment process unit 24, a log database 25, an ask-again key word database 26, an ask-again key word-2 database 27 and an information attribute content update condition database 28.

A control unit 29 controls an input, et cetera, that the operator carries out by using a key board, mouse, et cetera, and outputs a control signal for changing a parameter of each database and each process unit based on the input data. It also controls displaying of data for displaying necessary data.

The voice recognition process unit (for conversion from voice to text) 22, search process unit (searching for an ask-again, and searching for an incomprehensible pronunciation) 23, judgment process unit 24 and control unit 29 are programmed, and a central processing unit (CPU), et cetera, which carries out an (arithmetic and logical) operation process, is made to read and execute the program. The above described each process unit may be built on a printed circuit board by hardware.

The client database 21, log database 25, ask-again key word database 26, ask-again key word-2 database 27 and information attribute content update condition database 28 are constituted by memory, et cetera, which is used for recording data. Here, the memory may be RAM or ROM, or a recording apparatus such as an externally equipped hard disk, et cetera.

Effective updates are performed for the problems of the operator being unable to understand a content due to reasons, such as: (1) a rapid talk of a client makes it difficult to hear, (2) a bad pronunciation of a client makes it difficult to hear, (3) a client does not have knowledge on the product, by the comprisal shown in the block diagram of the above described FIG. 2.

The voice recognition process unit 22 receives an input of a voice signal uttered on the telephone (i.e., client's utterance (voice) and operator's utterance (voice)), converts the voice signal into a text and stores the text together with a date and time as a log file in the log database 25. It also enables to select, and display, a past log file from the log database 25 by means of the control unit 29.

The search process unit 23 performs an ask-again search and an incomprehensible pronunciation search. Each of the searches are described in details later. It inputs a log file converted from a conversation into a text file, which is generated by the voice recognition process unit 22, to the search process unit 23 from the log database 25. It carries out each of the above described search for the input log file by using the ask-again key word database 26 and ask-again key word-2 database 27, and transfers the search result to the judgment process unit 24.

The judgment process unit 24 obtains the search result, refers to the information attribute content update condition database 28 and updates the client database 21.

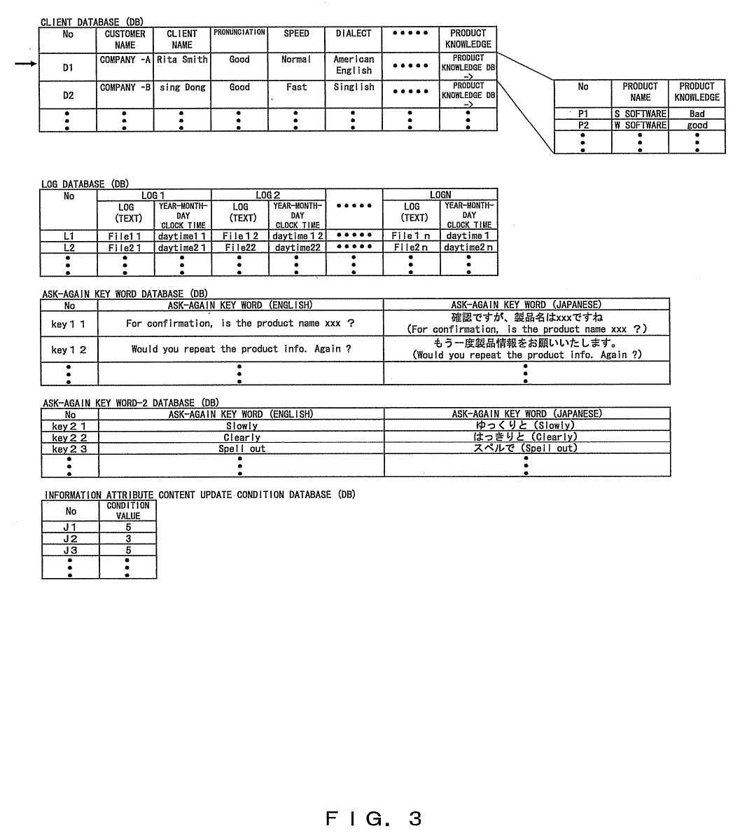

The client database 21 shown in FIG. 3 is constituted by items such as No., customer name, client name, pronunciation, speed, dialect, and product knowledge. For example, the stored items of information includes, in the No. “D1”: the customer name of “A company”, client name of “Rita Smith”, pronunciation of “good”, speed of “normal”, dialect of “American English”, et cetera. Also the stored items of information includes, in No. “D2”, the customer name of “B company”, client name of “Sing Dong”, pronunciation of “fast”, dialect of “Singlish” (i.e., a slang for Singaporean English).

Further stored items related to product information are a product name and a product knowledge level for each product and service which are in possession of a client. In the example shown in FIG. 3, stored are: No. “P1”, product name of “S_soft” and product knowledge of “bad”; and No. “P2”, product name of “W_soft”, product knowledge of “good”.

Here, the method for expressing the pronunciation, speed, and product knowledge uses an indication of stepwise levels, another method, however, such as a number, may be used in place of the configuration of the present embodiment. A method for determining the levels is described later.

The log database 25 stores No. and a past history of each client in the items LOG 1, LOG 2 through LOG N (a log (in text format); year, month, date) which are correlated with a log file and a management of date and time. For example, for No. “L1”, LOG 1 is correlated with “File 11” and “daytime 11”, LOG 2 is correlated with “File 12” and “daytime 12”, and LOG N is correlated with “File 1N” and “daytime 1N”.

For No. “L2”, LOG 1 is correlated with “File 21” and “daytime 21”, LOG 2 is correlated with “File 22” and “daytime 22”, and LOG N is correlated with “File 2N” and “daytime 2N”.

The ask-again key word database 26 is furnished with items such as No., ask-again keyword (in English), ask-again key word (in Japanese). For example, in No. “key 11”, an ask-again key word (in English) lists “For confirmation, is the product name xxx?”, and one (in Japanese, but translated into English for convenience herein) “For confirmation, is the product name xxx?”. Also in No. “key 12”, an ask-again keyword (in English) lists “Would you please repeat the product information again?”, and one (in Japanese, but translated into English for convenience herein) “Would you please repeat the product information?”

The ask-again key word-2 database 27 is furnished with items such as No., ask-again key word (in English), ask-again key word (in Japanese). For example, in No. “key 21”, an ask-again key word (in English) lists “Slowly”, and one (in Japanese, but translated into English for convenience herein) “Slowly”. Also in No. “key 22”, an ask-again key word (in English) lists “Clearly” and one (in Japanese; likewise translated into English) “Clearly”. Also in No. “key 23”, an ask-again key word (in English) lists “Spell out” and one (in Japanese; likewise translated into English) “Spell out”.

The information attribute content update condition database 28 is furnished with No. and a condition value. The No. is furnished with “J1”, “J2”, “J3”, et cetera, with each No. being set with the numbers of times of asking again of ask-again key word and of ask-again key word-2 which are used in the ask-again search and incomprehensibility search.

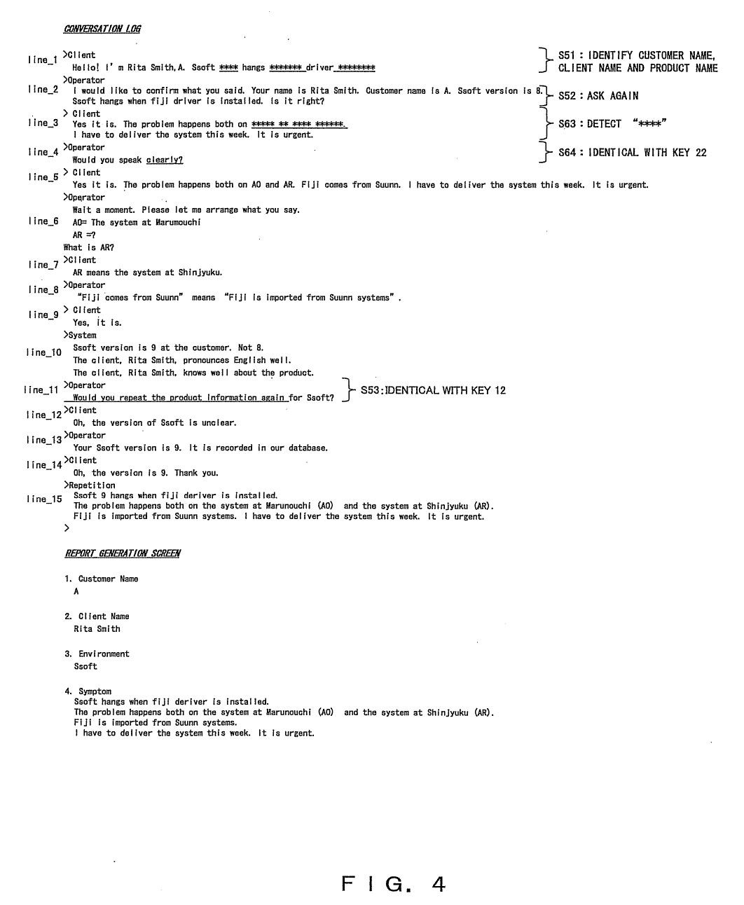

The next is a description on how to support a conversation with a client by referring to the text (i.e., the content of a log file) shown in FIG. 4.

The system 1 transmits an uttered voice of a client to the operator by utilizing a CTI and displays it in a screen. The operator confirms the customer name, client name and product name (i.e., an environment) from the voice and contents of the conversation displayed in the screen. She then copies the customer name, client name and product name of the line 1 or 2 of FIG. 4 to the corresponding parts of “REPORT GENERATION SCREEN” shown in FIG. 4, for example.

The system 1 also instructs an operation to be performed by the operator. An example instruction including “the client is a Singaporean speaking “Singlish”, requiring a conversion into natural English”, et cetera, is displayed, followed by an translation and transmission.

Meanwhile, if there is a word “box” (which is a unique terminology) in terminologies used by the client, or if there is a word “AO” (which is a unique terminology) indicating a server locating in their “Marunouchi Center”, making the operator unable to understand it as “body” (which is a standard terminology), or a server in a customer's site, and therefore she is unable to obtain accurate information. Therefore the operator cannot validate a consistency. Or, if words of “AO comes from the U.S.” (which is a wrong English sentence) cannot be comprehended as “AO is imported from the U.S.” (which is a correct English sentence), or if “A little bid” (as per Singlish) cannot be comprehended as “A little bit” (American English), the system 1 instructs an operation to be performed by the operator.

Furthermore, if a client speaks fact, the system 1 instructs a use of conversion software for converting the speech into a slow one. Or, if a pronunciation of a client is bad, the operator requests him to speak loudly and slowly. If a client has insufficient product knowledge, the system 1 instructs the operator to use an operator-initiated interview style and displays an interview format.

The operator confirms the instruction, followed by validating the unknowns with the client according to the instruction. Having finished the question and answer, and determined the inquiry content of the client, the operator repeats the determined content once again. The repeated content is copied to “4. Symptom” shown in FIG. 4.

The system 1 makes a report for the client and sends it thereto. Also, the system 1 translates English to Japanese and sends it to a support technician.

Here, having confirmed an unknown word or incorrect expression with the client, the system 1 examines the log of the conversation and updates the client database 21. That is, it updates a product knowledge item of the client database 21 based on the number of times of the operator asking again. It also updates a pronunciation item of the client database 21 based on the number of “****” (i.e., indiscernible character string) of the lines 1 and 2 shown in FIG. 4 for example.

<Description of a Search for an Ask-Again Related to Product Knowledge>

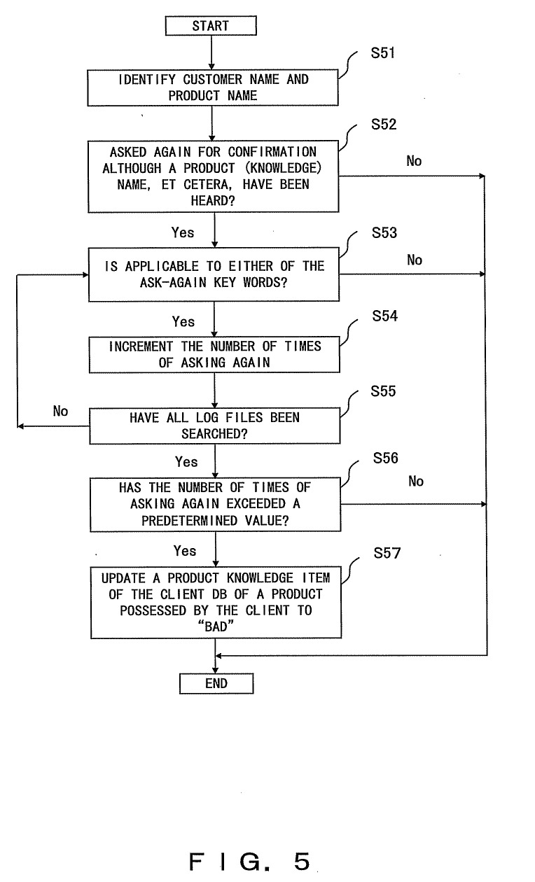

FIG. 5 is a diagram showing a flow chart of judging a presence or absence of product knowledge.

The step S51 identifies a record of the client database 21 from the customer name, client name and product name described in the log text generated by a voice recognition process. For example, it identifies the client indicated by the arrow shown in FIG. 3 according to the log of the line_1 shown in FIG. 4.

The step S52 judges whether the operator asked again in order to confirm although she has correctly heard the product name (or knowledge), et cetera, by referring to the log text, that is, by searching for an operator's conversation such as the line_2 shown in FIG. 4. If there is no such conversation found, it sidesteps from the flow shown in FIG. 5 without performing a process.

The step S53 searches whether the log file contains a character string applicable to either of the ask-again keywords. If such a character string is found as a result of the search, the process shifts to the step S54.

The same character string as one corresponding to “key 12” stored in the ask-again key word database 26 is detected in the example of shown in FIG. 4, and therefore the step S54 increments the number of times of asking again. A value of a furnished counter for example is incremented.

The step S55 confirms whether all the log files have been searched and, if the search is completed, shifts the process to step S56, otherwise shifts to the step S53 for proceeding with further search.

The step S56 judges whether the number of times of asking again has exceeded a predetermined value, by comparing a value indicated by the counter (i.e., a judgment result) with a corresponding condition value stored in the information attribute content update condition database 28. The judgment result is configured to allow discernment of a plurality of levels, e.g., three levels as “J1”=5 and “J2”=2. The level may be “good”, “normal” and “bad”.

The step S57 updates a product knowledge level of the client database 21 of the product corresponding to the client based on the judgment result. If a large number of times of asking again are found, it sets “bad” to the product knowledge item.

<Description of a Search for an Ask-Again Related to an Incomprehensible Pronunciation>

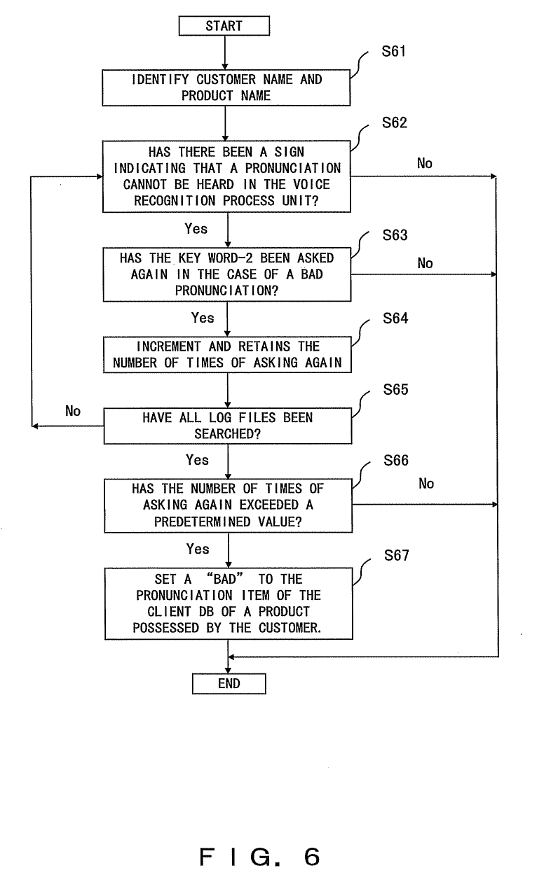

FIG. 6 is a diagram showing a judgment flow chart in the case of a bad pronunciation.

The step S61 identifies a client name and a product name as in the step S51.

The step S62 judges whether there has been an unknown pronunciation sign “****” indicating that a pronunciation cannot be heard in the voice recognition process, specifically by judging whether or not the ask-again was meant for a confirmation although the unknown pronunciation sign had been heard, by referring to a log text. It searches a point where the “****” exists on the line_3 of FIG. 4 from the conversation with the client. If such a point is not found, the process sidesteps the flow shown in FIG. 6 without performing a process.

The step S63 judges whether the key word-2 has been asked again in the case of a bad pronunciation. If such a point is found as a result of the search, it shifts the process to the step S64.

The same character string as one corresponding to the “key 22” stored in the ask-again key word-2 database 27 is detected according to the example shown in FIG. 4. In such an event, the step S64 increments the number of times of asking again, e.g., by furnishing a counter to increment a value thereof.

The step S65 confirms whether all log files have been searched and, if the search is completed, shifts the process to the step S66, otherwise shifts it to the step S63 for a further search.

The step S66 judges whether the number of times of asking again has exceeded a predetermined value, by comparing a value indicated by the counter (i.e., a judgment result) with the condition value stored in the information attribute content update condition database 28. The judgment result is configured to allow a discernment of a plurality of levels, e.g., three levels as “J3”=5 and “J4”=2. The level may be “good”, “normal” and “bad”.

The step S67 sets a “bad” to the pronunciation item if there have been a number of times of asking again, based on the judgment result.

The configuration as described above makes it possible to judge that a product knowledge level of a client is low and update an applicable attribute of the data base if the number of times of an operator asking again, which is extracted from a voice signal, is equal to or more than a predetermined value. Also made possible is to extract a point which a voice recognition system has been unable to recognize from the utterance of the client in the response log and, if the number of points equal to or more than a predetermined value is extracted, judge that the pronunciation of the client is bad and accordingly update the applicable attribute of the database of the client.

Note here that an embodiment of the present invention is possible by creating a control program for making a CPU of a standard computer execute the processes shown in the above described flow charts shown in FIGS. 5 and 6, storing the program in a computer readable recording medium, and making the CPU execute the program by having the computer read it from the recording medium.

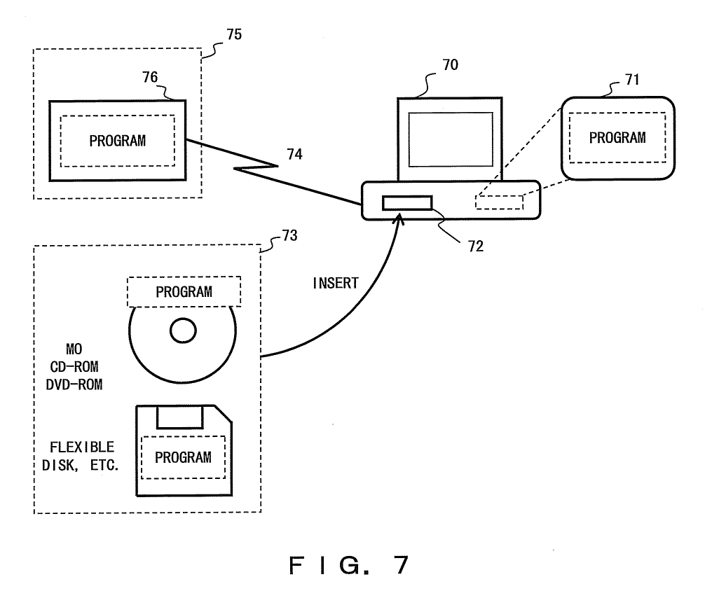

FIG. 7 is a diagram showing a configuration example of a recording medium allowing a computer to read a recorded control program. Such a recording medium can utilize, for example, a storage apparatus 71 such as ROM and hard disk apparatus comprised by a computer system 70 as a built-in or external ancillary apparatus, a portable storage medium, such as a flexible disk, magneto optical (MO) disk, CD-ROM, DVD-ROM, et cetera, allowing a readout of a recorded control program by inserting it into a media drive apparatus 72 which is comprised by the computer system 70, and et cetera.

The recording medium may be a storage apparatus 76 comprised by a computer system functioning as program server 75 which is connected to the computer system by way of a telecommunication line 74. In this case, a control program can be executed by the CPU of the computer system 70 by transmitting a transmission signal obtained by modulating a carrier wave by a data signal expressing the control program from the program server 75 to the computer system 70 by way of the telecommunication line 74 that is a transmission medium.

Also note that the present invention can be improved and/or changed in various manners possible within the scope thereof in lieu of being limited to the preferred embodiment as described above.

What is claimed is:

1. A reception support system supporting an operator by equipping computer telephony integration (CTI) for connecting an operator terminal with a client terminal by way of a telecommunication line, comprising:
a voice recognition process unit for generating a log file by converting a voice signal uttered from the client and operator terminals into a text, and storing the log file in a log database by being correlated with the client terminal;
a search process unit for recording a product knowledge level of each client as attribute information, detecting a presence of a point of the operator asking again in a text of the database by comparing with a character string, which is stored in an ask-again key word database, used when the operator asks again, and storing the number of times of being identical with the character string; and
a judgment process unit for selecting a level based on the aforementioned number of times by referring to an attribute information content update database including a condition of the number of times of asking again for changing the attribute information, and updating the product knowledge level in a database recording the attribute information for each client.

2. A reception support system supporting an operator by equipping computer telephony integration (CTI) for connecting an operator terminal with a client terminal by way of a telecommunication line, comprising:
a voice recognition process unit for generating a log file by converting a voice signal uttered from the client terminal and operator terminal into a text, and storing the log file in a log database by being correlated with the client terminal;
a search process unit for recording a pronunciation level of each client as attribute information, detecting a presence of a point of the operator asking again in a text of the database by comparing with a character string, which is stored in an ask-again key word-2 database, used when the operator asks again if a pronunciation is incomprehensible, and storing the number of times of being identical with the character string; and
a judgment process unit for selecting a level based on the aforementioned number of times by referring to an attribute information content update database including a condition of the number of times of asking again for changing the attribute information, and updating the pronunciation level in a database recording the attribute information for each client.

3. A computer readable recording medium recording a program for making a computer execute a reception support system supporting an operator by equipping computer telephony integration (CTI) for connecting an operator terminal with a client terminal by way of a telecommunication line, wherein the program makes the aforementioned computer execute:
a voice recognition process for generating a log file by converting a voice signal uttered from the client terminal and operator terminal into a text, and storing the log file in a log database by being correlated with the client terminal in order to update a database including a product knowledge level as attribute information of each client;
a search process for detecting a presence of a point of the operator asking again in a text of the database by comparing with a character string, which is stored in an ask-again key word database, used when the operator asks again, and storing the number of times of being identical with the character string; and
a judgment process for selecting a level based on the aforementioned number of times by referring to an attribute information content update database including a condition of the number of times of asking again for changing the attribute information, and updating the pronunciation level in a database recording the attribute information for each client.

4. A computer readable recording medium recording a program for making a computer execute a reception support system supporting an operator by equipping computer telephony integration (CTI) for connecting an operator terminal with a client terminal by way of a telecommunication line, wherein the program makes the aforementioned computer execute:
a voice recognition process for generating a log file by converting a voice signal uttered from the client terminal and operator terminal into a text, and storing the log file in a log database by being correlated with the client terminal in order to update a database including a product knowledge level as attribute information of each client;
a search process for detecting a presence of a point of the operator asking again in a text of the database by comparing with a character string, which is stored in an ask-again key word-2 database, used when the operator asks again if a pronunciation is incomprehensible, and storing the number of times of being identical with the character string; and
a judgment process for selecting a level based on the aforementioned number of times by referring to an attribute information content update database including a condition of the number of times of asking again for changing the attribute information, and updating the pronunciation level in a database recording the attribute information for each client.
